(19) United States
(12) Patent Application Publication
(10) Pub. No.: US 2026/0208995 A1
(43) Pub. Date: Jul. 23, 2026

(54) SHEET STACKING DEVICE

(71) Applicant: Toshiaki Oshiro, Izu Shizuoka (JP)

(72) Inventor: Toshiaki Oshiro, Izu Shizuoka (JP)

(73) Assignee: ETRIA CO., LTD., Kanagawa (JP)

(21) Appl. No.: 19/262,529

(22) Filed: Jul. 8, 2025

(30) Foreign Application Priority Data
Jan. 23, 2025 (JP) 2025-009918

(51) Int. Cl. B65H 31/18; B65H 31/10

(52) U.S. Cl. CPC B65H 31/18; B65H 31/10; B65H 2403/46; B65H 2801/06

(57) ABSTRACT

A sheet stacking device of an embodiment includes a drive motor, a tray, and a power transmission mechanism. The power transmission mechanism includes a first power transmission part and a second power transmission part. The second power transmission part is configured to reduce and transmit the power from the first power transmission part. The second power transmission part includes a worm gear and a worm wheel. The worm gear includes a gear shaft portion and a tooth portion. The worm wheel is engaged with the worm gear. The worm wheel has an engagement recessed portion. The engagement recessed portion is engaged with the tooth portion. The engagement recessed portion has a curved recessed shape corresponding to a shape of the tooth portion. A reduction ratio of the first power transmission part is greater than a reduction ratio from the second power transmission part to the tray.

### CROSS-REFERENCE TO RELATED APPLICATION

This application claims priority from Japanese Patent Application No. 2025-009918 filed on Jan. 23, 2025, the contents of which are incorporated herein by reference in their entirety.

### FIELD

Embodiments described herein relate to a sheet stacking device.

### BACKGROUND

A large-capacity sheet feeding device known as an example of a sheet stacking device, holds a large number of sheets supplied to an image forming device (for example, an MFP). The large-capacity sheet feeding device includes a drive motor, a power transmission mechanism, and a tray. A large number of sheets supplied to the image forming device are stacked onto the tray. A post-processing device known as another example of a sheet stacking device performs post-processing on sheets fed from the image forming device. For example, the post-processing device performs stapling or sorting on the fed sheets. The post-processing device includes a drive motor, a power transmission mechanism, and a tray. The tray stacks the sheets discharged after post-processing. The power transmission mechanism transmits power from the drive motor to raise and lower the tray. For example, the power transmission mechanism includes a worm gear and a worm wheel. In sheet stacking devices, there have been cases in which the power transmission mechanism generates noise.

### BRIEF DESCRIPTION OF DRAWINGS

FIG. 1 is a perspective view showing a post-processing device according to an embodiment.

FIG. 2 is a perspective view showing the post-processing device according to the embodiment.

FIG. 3 is a perspective view showing a power transmission mechanism of the post-processing device according to the embodiment.

FIG. 4 is a perspective view showing a configuration of the power transmission mechanism of the post-processing device according to the embodiment.

FIG. 5 is a perspective view showing a configuration of the power transmission mechanism of the post-processing device according to the embodiment.

FIG. 6 is a front view showing a part of the power transmission mechanism of the post-processing device according to the embodiment.

FIG. 7 is a perspective view showing a part of the power transmission mechanism of the post-processing device according to the embodiment.

FIG. 8 is a schematic view showing a structure of a second power transmission part of the power transmission mechanism of the post-processing device according to the embodiment.

FIG. 9 is a view showing an internal structure of the power transmission mechanism of the post-processing device according to the embodiment.

FIG. 10 is a diagram showing test results.

FIG. 11 is a diagram showing test results of an example.

FIG. 12 is a diagram showing test results of a comparative example.

### DETAILED DESCRIPTION

Hereinafter, a sheet stacking device of an embodiment will be described with reference to the drawings.

A sheet stacking device of an embodiment includes a drive motor, a power transmission mechanism, and a tray. The power transmission mechanism is configured to transmit power from the drive motor. The tray is capable of stacking of sheets thereon. The tray is configured to move up and down by the power transmitted through the power transmission mechanism. The power transmission mechanism includes a first power transmission part and a second power transmission part. The first power transmission part is configured to reduce and transmit the power from the drive motor. The second power transmission part is configured to reduce and transmit the power from the first power transmission part. The second power transmission part includes a worm gear and a worm wheel. The worm gear includes a gear shaft portion and a tooth portion. The gear shaft portion is rotationally driven by the power from the first power transmission part. The gear shaft portion has an outer circumferential surface. The tooth portion has a helical shape. The tooth portion is on the outer circumferential surface of the gear shaft portion. The worm wheel is engaged with the worm gear. The worm wheel has an engagement recessed portion. The engagement recessed portion is engaged with the tooth portion. The engagement recessed portion has a curved recessed shape corresponding to a shape of the tooth portion when viewed from a direction parallel to a worm-gear axis of the worm gear. A reduction ratio of the first power transmission part is greater than a reduction ratio from the second power transmission part to the tray.

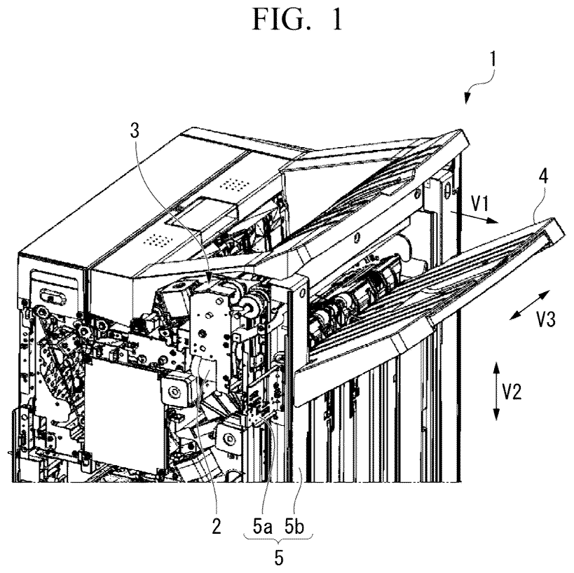

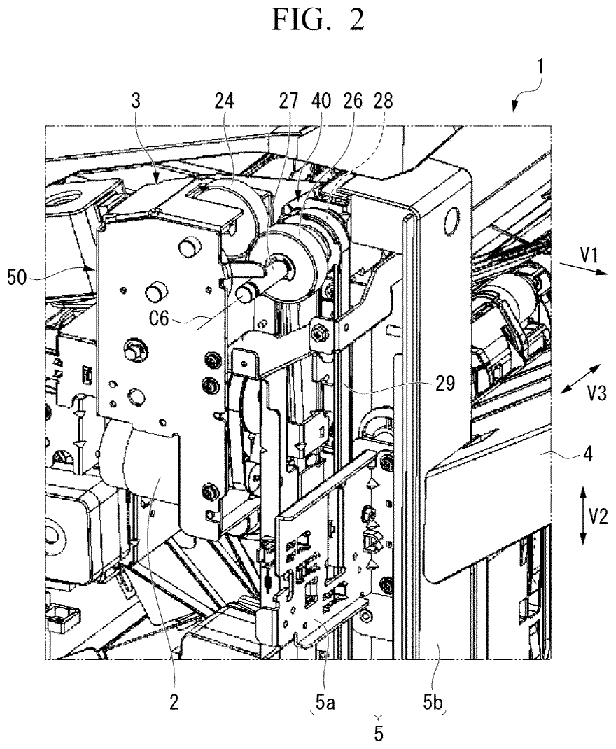

FIGS. 1 and 2 are perspective views showing a post-processing device 1 according to an embodiment. As shown in FIGS. 1 and 2, the post-processing device 1 includes a drive motor 2, a power transmission mechanism 3, a sheet discharge tray 4 (tray), and a guide mechanism 5. The post-processing device 1 is an example of a sheet stacking device.

The post-processing device 1 is disposed adjacent to an image forming device. Sheets are fed from the image forming device to the post-processing device 1. The post-processing device 1 performs post-processing on the fed sheets. Post-processing is specified through a control panel that receives an operation of a user. For example, the post-processing device 1 performs stapling processing and sorting processing. For example, the post-processing device 1 performs a sheet folding processing. In the sheet folding processing, a sheet is folded in half and discharged.

The sheet discharge tray 4 is capable of stacking the discharged sheets thereon. For example, sheets (sheet bundles) that were subjected to post-processing (stapling processing, sorting processing, or the like) are discharged onto the sheet discharge tray 4 by a conveying belt. The sheet discharge tray 4 receives the discharged sheets. The sheet discharge tray 4 is raised and lowered using a rotational force of the drive motor 2. For example, the sheet discharge tray 4 has a rectangular plate shape. In the rectangular plate shape, the longitudinal direction of the sheet discharge tray 4 is parallel to a sheet width direction V3. The sheet width direction V3 is orthogonal to a sheet discharge direction V1 and a vertical direction V2.

The guide mechanism 5 guides the sheet discharge tray 4 vertically. For example, the guide mechanism 5 includes two guide plates 5a and two guide rails 5b.

The two guide plates 5a are provided apart from each other in the sheet width direction V3. Of the two guide plates 5a, a first guide plate 5a is attached to one end (first end) of the sheet discharge tray 4. Of the two guide plates 5a, a second guide plate 5a is attached to the other end (second end) of the sheet discharge tray 4. The guide plates 5a extend outward from both ends of the sheet discharge tray 4 (both ends in the sheet width direction V3). At least one of the guide plates 5a is connected to a timing belt 29 (see FIG. 2).

The two guide rails 5b are provided apart from each other in the sheet width direction V3. Of the two guide rails 5b, a first guide rail 5b is provided on one side (first side) of the sheet discharge tray 4. Of the two guide rails 5b, a second guide rail 5b is provided on the other side (second side) of the sheet discharge tray 4. The guide rails 5b extend in the vertical direction V2. The guide rails 5b guide the guide plates 5a. The sheet discharge tray 4 is guided along the guide rails 5b via the guide plates 5a.

The drive motor 2 raises and lowers the sheet discharge tray 4 via the power transmission mechanism 3. The drive motor 2 is capable of controlling a rotation angle and a rotation speed. For example, the drive motor 2 is a DC motor. The post-processing device 1 includes a controller configured to control rotation of the drive motor 2. For example, the drive motor 2 includes a drive circuit. The drive circuit is drive-controlled by the controller.

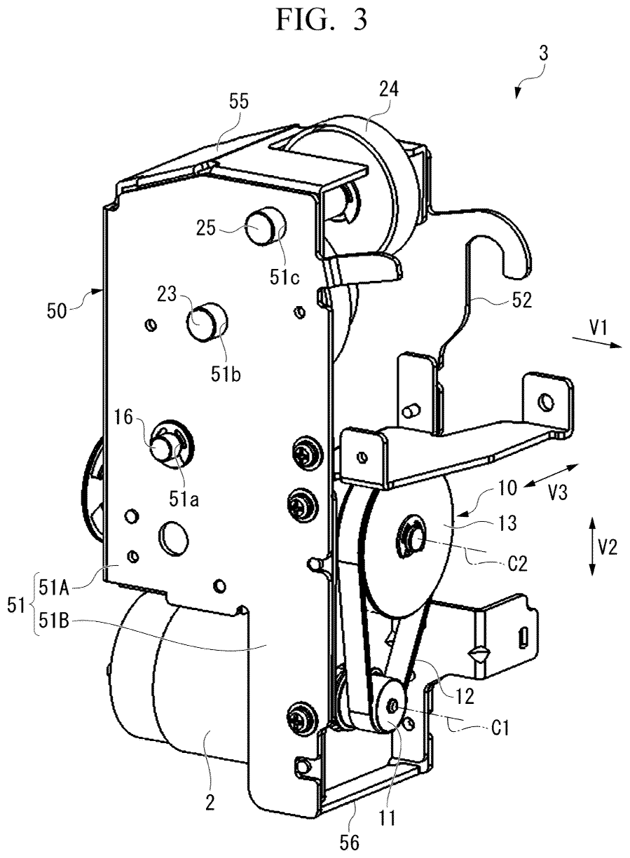

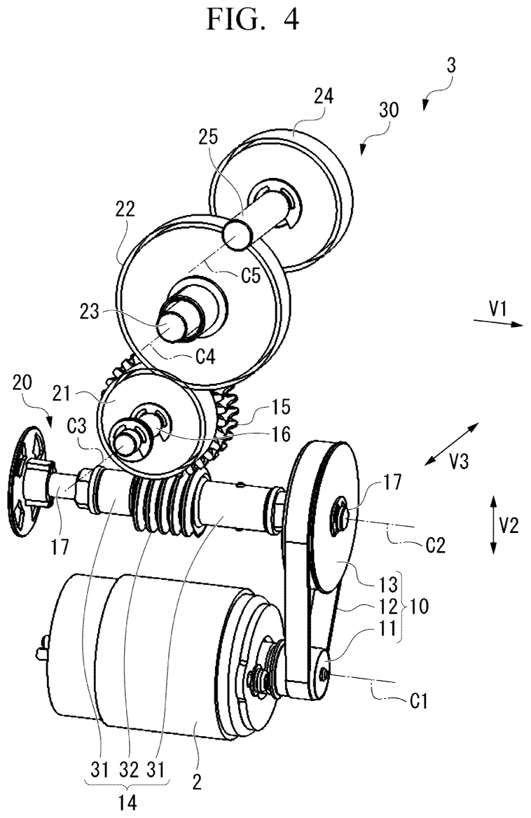

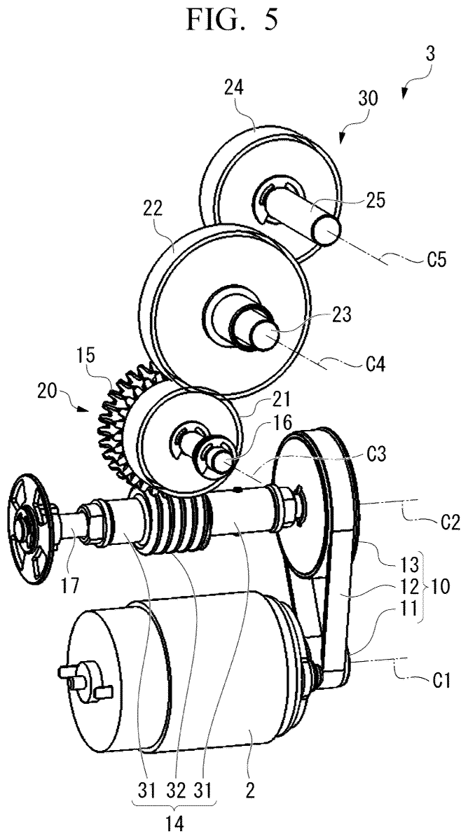

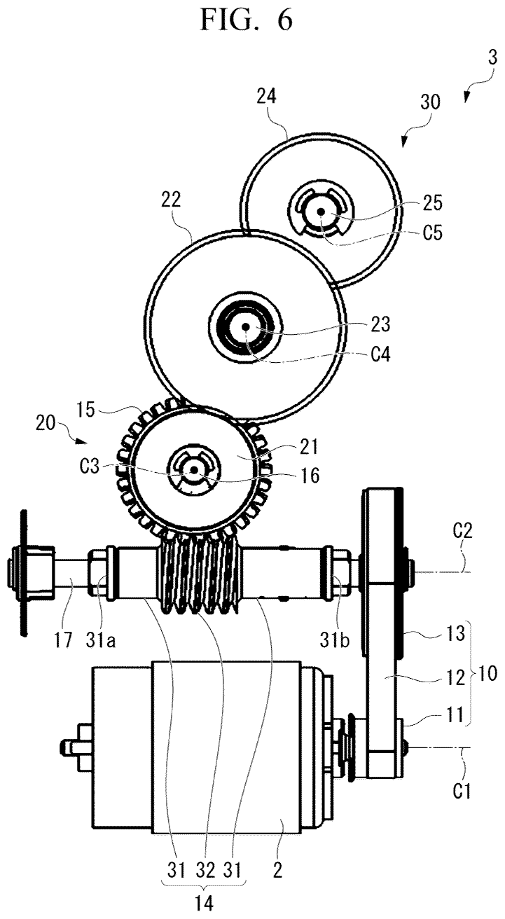

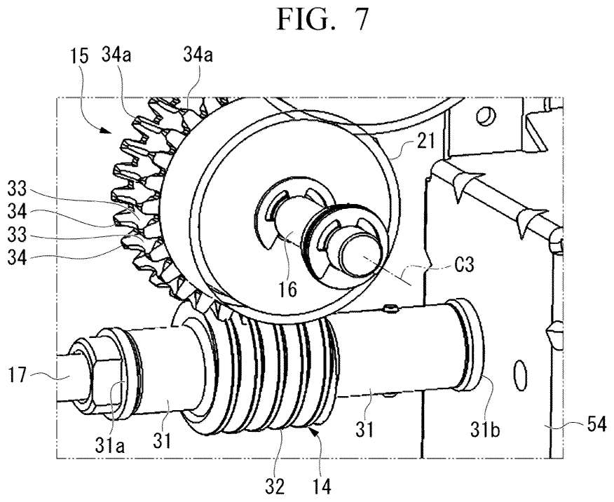

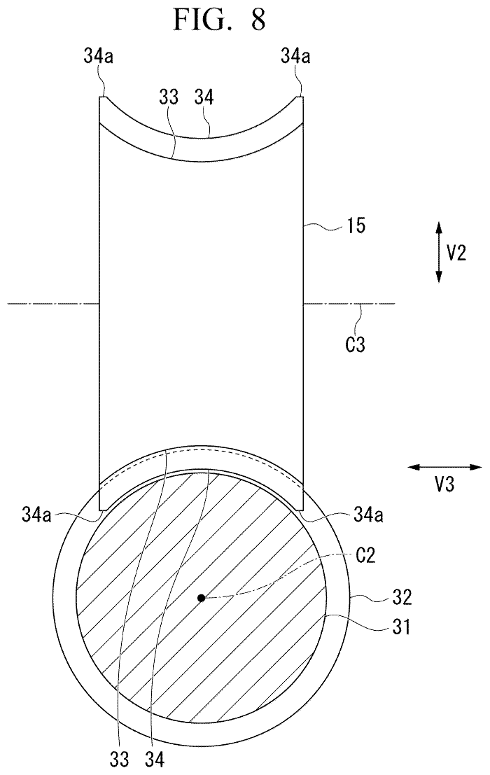

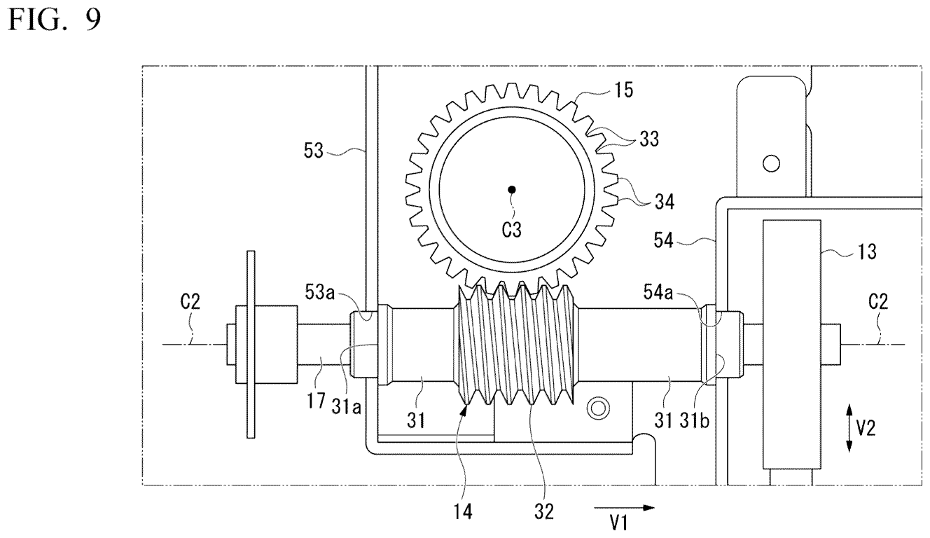

FIG. 3 is a perspective view showing the power transmission mechanism 3. FIGS. 4 and 5 are perspective views showing a configuration of the power transmission mechanism 3. FIG. 6 is a front view showing a part of the power transmission mechanism 3. FIG. 7 is a perspective view showing a part of the power transmission mechanism 3. FIG. 8 is a schematic view showing a structure of a second power transmission part 20. FIG. 9 is a view showing an internal structure of the power transmission mechanism 3.

As shown in FIG. 3, the power transmission mechanism 3 includes a first power transmission part 10, the second power transmission part 20 (see FIG. 4), a third power transmission part 30 (see FIG. 4), a fourth power transmission part 40 (see FIG. 2), and a support structure 50. The power transmission mechanism 3 is capable of transmitting power from the drive motor 2 to the sheet discharge tray 4.

As shown in FIGS. 4 to 6, the first power transmission part 10 includes a motor pulley 11 (first pulley), a motor drive belt 12 (belt), a worm gear pulley 13 (second pulley), and a first shaft 17. The first power transmission part 10 reduces power from the drive motor 2 and transmits the reduced power to the second power transmission part 20. In FIGS. 4 to 6, reference sign C1 indicates an axis of a rotating shaft of the drive motor 2. Reference sign C2 indicates an axis of a shaft portion of a worm gear 14. Reference sign C3 indicates an axis of a worm wheel shaft 16.

The motor pulley 11 is attached to the rotating shaft of the drive motor 2. The motor drive belt 12 is stretched between the motor pulley 11 and the worm gear pulley 13. The motor drive belt 12 is wound around the motor pulley 11. The motor drive belt 12 transmits power from the motor pulley 11 to the worm gear pulley 13. The worm gear pulley 13 rotates due to driving of the motor drive belt 12 and thereby rotationally drive the worm gear 14. The worm gear pulley 13 is attached to the first shaft 17.

The second power transmission part 20 includes the worm gear 14, a worm wheel 15, and the worm wheel shaft 16. The second power transmission part 20 reduces power from the first power transmission part 10 and transmits it to the third power transmission part 30.

The worm gear 14 has the axis C2 parallel to the axis C1 of the drive motor 2. The axis C2 is an example of a worm-gear axis. The worm gear 14 is engaged with a worm wheel 15.

The worm gear 14 includes a gear shaft portion 31 having the axis C2 and a tooth portion 32 formed on an outer circumferential surface of the gear shaft portion 31. The tooth portion 32 is formed in a helical shape with the axis C2 as a central axis. An outer circumferential edge of the tooth portion 32 is formed in a circular shape when viewed in a direction parallel to the axis C2 (see FIG. 8). The first shaft 17 having the axis C2 is inserted through the worm gear 14. In other words, the worm gear 14 is formed on an outer circumferential surface of the first shaft 17.

As shown in FIGS. 7 and 8, a plurality of engagement recessed portions 33 and a plurality of engagement protruding portions 34 are formed on an outer circumferential surface of the worm wheel 15. The engagement recessed portions 33 and the engagement protruding portions 34 are formed to be alternately aligned in a circumferential direction of the worm wheel 15. The tooth portion 32 of the worm gear 14 is engaged with the engagement recessed portions 33. The engagement recessed portions 33 are formed at regular intervals in the circumferential direction of the worm wheel 15.

As shown in FIG. 8, the engagement recessed portion 33 is formed in a curved recessed shape corresponding to a shape of the tooth portion 32 of the worm gear 14 when viewed in the direction parallel to the axis C2 of the worm gear 14. The engagement recessed portion 33 is formed in a curved recessed shape (arcuate shape) corresponding to a curved convex shape (arcuate shape) of the outer circumferential edge of the tooth portion 32 when viewed in the direction parallel to the axis C2. In FIG. 8 showing a cross-section orthogonal to the axis C2, a distance between an inner circumferential edge of the engagement recessed portion 33 and an outer circumferential edge of the tooth portion 32 is constant on a circumference of the tooth portion 32. Here, the “distance” means the distance between an inner circumferential position of the engagement recessed portion 33 and an outer circumferential position of the tooth portion 32 in a radial direction from the center position corresponding to the axis C2 in FIG. 8. The engagement recessed portion 33 is deepest at a center in a thickness direction of the worm wheel 15. The tooth portion 32 fits into the engagement recessed portion 33. A shape (curved recessed shape) of the engagement recessed portions 33 when viewed from the direction parallel to the axis C2 is not limited to an arcuate shape, and may also be an elliptical arc shape, a quadratic curve shape, or the like. The direction parallel to the axis C2 is a direction parallel to a tangent of an outer circumferential edge of the worm wheel 15.

The engagement protruding portion 34 is formed in a curved recessed shape (arcuate shape) corresponding to a curved convex shape (arcuate shape) of an outer circumferential surface of the gear shaft portion 31 when viewed in the direction parallel to the axis C2. A shape (curved recessed shape) of the engagement protruding portion 34 when viewed from the direction parallel to the axis C2 is not limited to an arcuate shape, and may also be an elliptical arc shape, a quadratic curve shape, or the like.

A notch 34a is formed at each of one end (first end) and the other end (second end) of the engagement protruding portion 34. The notch 34a has a shape in which a portion including a distal end of the engagement protruding portion 34 is cut away. In other words, each of the plurality of engagement protruding portions 34 has a first end and a second end when viewed from a direction parallel to the axis C2 of the worm gear 14. That is, in FIG. 8 showing the cross-section orthogonal to the axis C2, one end of the worm wheel 15 in the direction orthogonal to the axis C2 is the first end, and the other end of the worm wheel 15 in the direction orthogonal to the axis C2 is the second end. The first end has a first notch. The second end has a second notch. The first notch has a shape in which a portion including the first notch is cut away. The second notch has a shape in which a portion including the second notch is cut away. A degree of inclination (slope) of an inner circumferential edge of the engagement protruding portion 34 with respect to the axis C3 increases in a direction approaching a main surface of the worm wheel 15, and decreases at the notch 34a. For example, an end surface of the notch 34a is a surface perpendicular to a radial direction of the worm wheel 15. For example, the end surface of the notch 34a is a surface parallel to the axis C3. The term “main surface” refers to one surface (first surface) and the other surface (second surface) of the plate-shaped worm wheel 15. The main surface is a surface perpendicular to the axis C3.

As shown in FIGS. 4 to 6, the worm wheel shaft 16 has the axis C3 intersecting the axis C2 of the gear shaft portion 31 of the worm gear 14. For example, the axis C3 of the worm wheel shaft 16 is orthogonal to the axis C2. The axis C3 is an example of a worm-wheel axis. The worm wheel 15 is attached to the worm wheel shaft 16.

For example, the worm gear 14 and the worm wheel 15 are formed of a resin. Examples of resins constituting the worm gear 14 and the worm wheel 15 include polyacetal, fluororesin, or the like.

The third power transmission part 30 includes a first gear 21, a second gear 22, a second shaft 23, a third gear, a fourth gear 24, and a third shaft 25. The third power transmission part 30 transmits power from the second power transmission part 20 to the fourth power transmission part 40. The number of gears constituting the third power transmission part may be one or more.

The first gear 21 is attached to the worm wheel shaft 16. The first gear 21 is disposed coaxially with the worm wheel 15. The first gear 21 and the worm wheel 15 are integrally rotatable.

The second gear 22 and the third gear are attached to the second shaft 23. The second gear 22 is engaged with the first gear 21. The third gear is disposed coaxially with the second gear 22. The second gear 22 and the third gear are integrally rotatable. The second shaft 23 has an axis C4 parallel to the axis C3 of the worm wheel shaft 16.

The fourth gear 24 is attached to the third shaft 25. The fourth gear 24 is engaged with the third gear. The third shaft 25 has an axis C5 parallel to the axis C4 of the second shaft 23.

For example, at least one of the first gear 21, the second gear 22, the third gear, and the fourth gear 24 is formed of a resin. Only one of the first gear 21, the second gear 22, the third gear, and the fourth gear 24 may be formed of a resin, or all of them may be formed of a resin. Examples of the resin include polyacetal, fluororesin, or the like.

As shown in FIG. 2, the fourth power transmission part 40 transmits power from the third power transmission part 30 to the sheet discharge tray 4 via the guide mechanism 5.

The fourth power transmission part 40 includes a fifth gear 26, a fourth shaft 27, a timing pulley 28, and the timing belt 29.

The fifth gear 26 is attached to the fourth shaft 27. The fifth gear 26 is engaged with the fourth gear 24. The fourth shaft 27 has an axis C6 parallel to the axis C5 of the third shaft 25. The timing pulley 28 is attached to the fourth shaft 27. The timing pulley 28 is disposed coaxially with the fifth gear 26. The fifth gear 26 and the timing pulley 28 are integrally rotatable. The timing belt 29 is wound around the timing pulley 28. The timing pulley 29 rotates in accordance with rotation of the timing pulley 28.

A reduction ratio of the first power transmission part 10 is greater than a reduction ratio from the second power transmission part 20 to the sheet discharge tray 4. The reduction ratio from the second power transmission part 20 to the sheet discharge tray 4 is a reduction ratio of the second to fourth power transmission parts 20, 30, and 40. In other words, the reduction ratio of the second to fourth power transmission parts 20, 30, and 40 is the reduction ratio from the second power transmission part 20 to the fourth power transmission part 40 via the third power transmission part 30.

As shown in FIG. 3, the support structure 50 includes a first main plate 51, a second main plate 52, a first side plate 53 (see FIG. 9), a second side plate 54 (see FIG. 9), a top plate 55, and a connection portion 56. The first side plate 53 and the second side plate 54 are examples of a “support portion”.

The first main plate 51 includes a rectangular main portion 51A and an extension portion 51B extending from a lower end of the main portion 51A. For example, the first main plate 51 is parallel to the discharge direction V1 and the vertical direction V2.

A first support hole 51a, a second support hole 51b, and a third support hole 51c are formed in the main portion 51A. The first support hole 51a, the second support hole 51b, and the third support hole 51c penetrate the main portion 51A in a thickness direction. For example, the first support hole 51a, the second support hole 51b, and the third support hole 51c are formed in a circular shape. A portion including one end (first end) of the worm wheel shaft 16 is inserted through the first support hole 51a. A portion including one end (first end) of the second shaft 23 is inserted through the second support hole 51b. A portion including one end (first end) of the third shaft 25 is inserted through the third support hole 51c.

The second main plate 52 faces the first main plate 51 with a gap therebetween in the sheet width direction V3. For example, the second main plate 52 is parallel to the first main plate 51. The first to third support holes are also formed in the second main plate 52. A portion including the other end (second end) of the worm wheel shaft 16 is inserted through the first support hole of the second main plate 52. A portion including the other end (second end) of the second shaft 23 is inserted through the second support hole of the second main plate 52. A portion including the other end (second end) of the third shaft 25 is inserted through the third support hole of the second main plate 52.

The first main plate 51 and the second main plate 52 rotatably support the worm wheel shaft 16, the second shaft 23, and the third shaft 25.

As shown in FIG. 9, for example, the first side plate 53 is perpendicular to the first main plate 51 and the second main plate 52 (see FIG. 3). A support hole 53a is formed in the first side plate 53. The first shaft 17 is inserted through the support hole 53a. The second side plate 54 faces the first side plate 53 with a gap therebetween in the discharge direction V1. For example, the second side plate 54 is parallel to the first side plate 53. A support hole 54a is formed in the second side plate 54. The first shaft 17 is inserted through the support hole 54a. The first side plate 53 and the second side plate 54 rotatably support the worm gear 14 via the first shaft 17.

The first side plate 53 faces one end portion 31a (first end portion) of the gear shaft portion 31 of the worm gear 14. The second side plate 54 faces the other end portion 31b (second end portion opposite to the first end portion) of the gear shaft portion 31 of the worm gear 14.

As shown in FIG. 3, the top plate 55 is formed to extend from an upper end of the first main plate 51 to an upper end of the second main plate 52. The connection portion 56 connects a lower end of the first main plate 51 and a lower end of the second main plate 52.

For example, the support structure 50 is formed of a metal such as an aluminum alloy or stainless steel.

Power transmission of the drive motor 2 will be described.

As shown in FIG. 4, rotational power of the drive motor 2 is transmitted to the worm gear 14 via the motor pulley 11, the motor drive belt 12, and the worm gear pulley 13. The power of the worm gear 14 is transmitted to the worm wheel 15. The worm wheel 15 rotates in conjunction with rotation of the worm gear 14. The first gear 21 rotates integrally with the worm wheel 15. As the first gear 21 rotates, the second gear 22, the third gear, and the fourth gear 24 rotate.

As shown in FIG. 2, when the fourth gear 24 rotates, the fifth gear 26 and timing pulley 28 rotate. As the timing pulley 28 rotates, the timing belt 29 rotates. The guide plate 5a moves up and down in accordance with the rotation (vertical movement) of the timing belt 29. The sheet discharge tray 4 moves up and down together with the guide plate 5a. For example, when the drive motor 2 rotates forward, the sheet discharge tray 4 is raised. When the drive motor 2 rotates in reverse, the sheet discharge tray 4 is lowered.

### Example 1

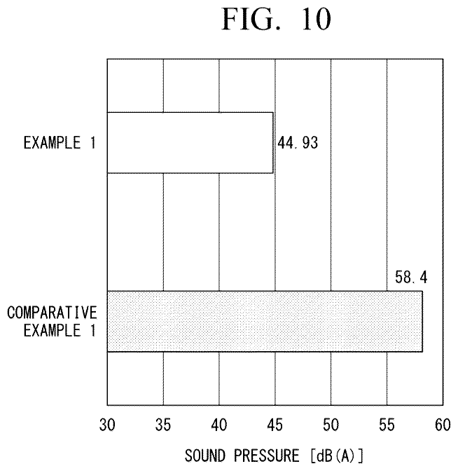

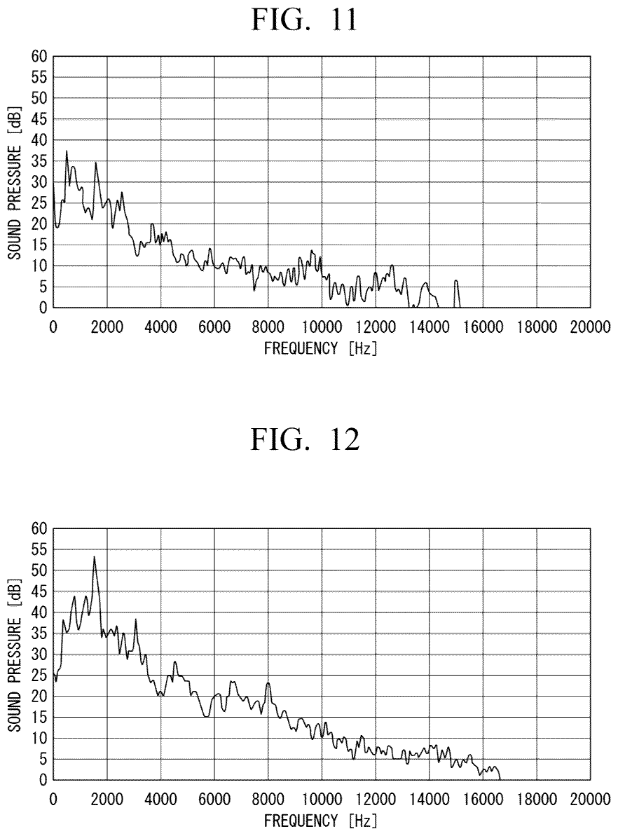

In the post-processing device 1 shown in FIG. 1, a sound pressure of noise generated when the sheet discharge tray 4 is raised was measured. A reduction ratio of the first power transmission part 10 is 2.9. A reduction ratio of the second to fourth power transmission parts 20, 30, and 40 (that is, a reduction ratio from the second power transmission part 20 to the sheet discharge tray 4) is 1.8. The worm gear 14 and the worm wheel 15 are formed of polyacetal. Results of measuring a sound pressure of the noise generated when the sheet discharge tray 4 is raised are shown in FIG. 10. Results of a frequency analysis of the noise generated when the sheet discharge tray 4 is raised are shown in FIG. 11. In FIG. 11, the vertical axis represents a sound pressure, and the horizontal axis represents a frequency.

### Comparative Example 1

A post-processing device of comparative example 1 differs from that of example 1 in that a helical gear is used instead of the worm wheel 15. A reduction ratio of a power transmission part in the post-processing device of comparative example 1 differs from that in example 1. A reduction ratio of a first power transmission part is 1.5. A reduction ratio of second to fourth power transmission parts is 3.5. The helical gear is formed of carbon fiber reinforced nylon. Results of measuring a sound pressure of the noise generated when the sheet discharge tray 4 is raised are shown in FIG. 10. Results of a frequency analysis of the noise generated when the sheet discharge tray 4 is raised are shown in FIG. 12. In FIG. 12, the vertical axis represents a sound pressure, and the horizontal axis represents a frequency.

As shown in FIGS. 10 to 12, in example 1, the noise generated by the power transmission mechanism 3 could be suppressed compared to that in comparative example 1.

In the post-processing device 1 according to the embodiment, the worm wheel 15 has the engagement recessed portions 33 having a curved recessed shape corresponding to a shape of the tooth portion 32 of the worm gear 14. With this configuration of the post-processing device 1, a contact area between the worm wheel 15 and the worm gear 14 is increased. Therefore, deformation of the worm gear 14 and the worm wheel 15 during driving is less likely to occur, and noise is less likely to generate. In the post-processing device 1, a reduction ratio of the first power transmission part 10 is greater than a reduction ratio from the second power transmission part 20 to the sheet discharge tray 4. Therefore, a rotation speed of the worm gear 14 can be reduced, thereby further suppressing noise generation.

The worm gear 14 is formed of a resin. Therefore, even if a large thrust force is applied to the worm gear 14, wear due to contact with the side plates 53 and 54 can be reduced (see FIG. 9). Since the worm gear 14 is formed of a resin, noise can be reduced compared to when a metal worm gear is used. Since the worm gear 14 is formed of a resin, a material cost can be reduced compared to when a metal worm gear is used.

The first power transmission part 10 includes the motor pulley 11, the motor drive belt 12, and the worm gear pulley 13. Therefore, the reduction ratio can be easily adjusted by setting diameters of the motor pulley 11 and the worm gear pulley 13.

Since at least one of the gears (the first gear 21, the second gear 22, the third gear, and the fourth gear 24) constituting the third power transmission part 30 is formed of a resin, noise generation can be further reduced.

In the post-processing device 1, the first side plate 53 and the second side plate 54 face the end portions 31a and 31b of the gear shaft portion 31 of the worm gear 14, respectively (see FIG. 9). Since the worm gear 14 is formed of a resin, even if a large thrust force is applied to the worm gear 14, wear due to contact with the side plates 53 and 54 can be reduced.

The engagement protruding portion 34 has the notch 34a formed at one end portion and the other end portion. Therefore, damage to the end portions is less likely to occur.

In the post-processing device 1, both end portions of the gear shaft portion 31 of the worm gear 14 face the side plates (support portions), respectively. In the post-processing device, one side plate may be provided to face one end portion of the gear shaft portion. That is, the post-processing device may have at least one side plate provided to face at least one end portion of the gear shaft portion.

The post-processing device 1 is an example of the sheet stacking device. Another example of the sheet stacking device is a large-capacity sheet feeding device. A large-capacity sheet feeding device holds a large number of sheets to be supplied to an image forming device (for example, an MFP). The large-capacity sheet feeding device includes a drive motor, a power transmission mechanism, and a tray. Sheets supplied to the image forming device are stacked in large quantities on the tray.

An additional statement related to the embodiment is disclosed.
(Additional statement 1) A sheet stacking device including:
a drive motor;
a power transmission mechanism configured to transmit power from the drive motor; and
a tray capable of stacking of sheets thereon, the tray configured to move up and down by the power transmitted through the power transmission mechanism, wherein
the power transmission mechanism includes:
   a first power transmission part configured to reduce and transmit the power from the drive motor; and
   a second power transmission part configured to reduce and transmit the power from the first power transmission part,
the second power transmission part includes:
   a worm gear having a gear shaft portion and a tooth portion, the gear shaft portion being rotationally driven by the power from the first power transmission part, the gear shaft portion having an outer circumferential surface, the tooth portion having a helical shape, the tooth portion being on the outer circumferential surface of the gear shaft portion; and
   a worm wheel engaged with the worm gear, and wherein
the worm wheel has an engagement recessed portion,
the engagement recessed portion is engaged with the tooth portion,
the engagement recessed portion has a curved recessed shape corresponding to a shape of the tooth portion when viewed from a direction parallel to a worm-gear axis of the worm gear, and
a reduction ratio of the first power transmission part is greater than a reduction ratio from the second power transmission part to the tray.
(Additional statement 2) The sheet stacking device according to additional statement 1, wherein
in a cross-section orthogonal to the worm-gear axis, a distance between an inner circumferential edge of the engagement recessed portion and an outer circumferential edge of the tooth portion is constant on a circumference of the tooth portion.
(Additional statement 3) The sheet stacking device according to additional statement 1, further including
support portions configured to rotatably support the worm gear, wherein
at least one of the support portions faces at least one end portion of the gear shaft portion, and
the worm gear includes a resin.
(Additional statement 4) The sheet stacking device according to additional statement 1, wherein
the first power transmission part includes:
   a first pulley attached to a rotating shaft of the drive motor;
   a belt wound around the first pulley to transmit the power from the first pulley; and
   a second pulley configured to rotate due to driving of the belt and thereby rotationally drive the gear shaft portion.
(Additional statement 5) The sheet stacking device according to additional statement 4, wherein
the first power transmission part includes a first shaft,
the second pulley is attached to the first shaft,
the belt is stretched between the first pulley and the second pulley,
the belt transmits the power from the first pulley to the second pulley, and
the second pulley rotates due to driving of the belt and thereby rotationally drive the worm gear.
(Additional statement 6) The sheet stacking device according to additional statement 1, wherein
the power transmission mechanism further includes a third power transmission part configured to reduce and transmit the power from the second power transmission part; and
at least one of gears constituting the third power transmission part includes a resin.
(Additional statement 7) The sheet stacking device according to additional statement 6, wherein
the third power transmission part includes a first gear, a second gear, a third gear, a fourth gear, a second shaft, and a third shaft.
(Additional statement 8) The sheet stacking device according to additional statement 7, wherein
the second power transmission part includes a worm wheel shaft,
the first gear is attached to the worm wheel shaft,
the first gear is disposed coaxially with the worm wheel, and
the first gear and the worm wheel are integrally rotatable.
(Additional statement 9) The sheet stacking device according to additional statement 8, wherein
the second gear and the third gear are attached to the second shaft,
the second gear is engaged with the first gear,
the third gear is disposed coaxially with the second gear,
the second gear and the third gear are integrally rotatable,
the second shaft is parallel to the worm wheel shaft,
the fourth gear is attached to the third shaft,
the fourth gear is engaged with the third gear, and
the third shaft is parallel to the second shaft.
(Additional statement 10)The sheet stacking device according to additional statement 7, wherein
the power transmission mechanism further includes a fourth power transmission part,
the fourth power transmission part includes a fifth gear, a fourth shaft, a timing pulley, and the timing belt, and
the third power transmission part is configured to transmit the power from the second power transmission part to the fourth power transmission part.
(Additional statement 11)The sheet stacking device according to additional statement 10, wherein
the fifth gear is attached to the fourth shaft,
the fifth gear is engaged with the fourth gear,
the fourth shaft is parallel to the third shaft,
the timing pulley is attached to the fourth shaft,
the timing pulley is disposed coaxially with the fifth gear,
the fifth gear and the timing pulley are integrally rotatable,
the timing belt is wound around the timing pulley, and
the timing pulley is configured to rotate in accordance with rotation of the timing pulley.
(Additional statement 12)The sheet stacking device according to additional statement 10, wherein
the fourth power transmission part is configured to transmit power from the third power transmission part to the tray.
(Additional statement 13)The sheet stacking device according to additional statement 10, wherein
a reduction ratio from the second power transmission part the tray is a reduction ratio from the second power transmission part to the fourth power transmission part via the third power transmission part.
(Additional statement 14)The sheet stacking device according to additional statement 3, including
two support portions, wherein
one of the two support portions faces a first end portion of the gear shaft portion,
the other of the two support portions faces a second end portion of the gear shaft portion, and
the second end portion is opposite to the first end portion.
(Additional statement 15)The sheet stacking device according to additional statement 1, wherein
the worm wheel has a plurality of engagement recessed portions and a plurality of engagement protruding portions,
the plurality of engagement recessed portions and the plurality of engagement protruding portions are alternately formed,
each of the plurality of engagement protruding portions has a first end and a second end when viewed from a direction parallel to the worm-gear axis,
the first end has a first notch,
the second end has a second notch,
the first notch has a shape in which a portion including the first notch is cut away, and
the second notch has a shape in which a portion including the second notch is cut away.
(Additional statement 16)The sheet stacking device according to additional statement 15, wherein
the worm wheel has a worm-wheel axis,
the worm-wheel axis is orthogonal to the worm-gear axis,
the worm wheel has a main surface perpendicular to the worm-wheel axis, and
a degree of inclination of an inner circumferential edge of the engagement protruding portion with respect to the worm-wheel axis increases in a direction approaching the main surface and decreases at each of the first notch and the second notch.
(Additional statement 17)The sheet stacking device according to additional statement 15, wherein
an end surface of each of the first notch and the second notch is a surface perpendicular to a radial direction of the worm wheel.
(Additional statement 18)The sheet stacking device according to additional statement 15, wherein
the worm wheel has a worm-wheel axis,
the worm-wheel axis is orthogonal to the worm-gear axis,
an end surface of each of the first notch and the second notch is a surface parallel to the worm-wheel axis.
(Additional statement 19)The sheet stacking device according to additional statement 8, wherein
the power transmission mechanism includes a support structure, and
the support structure includes a first main plate, a second main plate, a first side plate, a second side plate, a top plate, and a connection portion.
(Additional statement 20)The sheet stacking device according to additional statement 19, wherein
the first main plate and the second main plate rotatably support the worm wheel shaft, the second shaft, and the third shaft.

According to at least one of the embodiments described above, the worm wheel 15 has the engagement recessed portions 33 having a curved recessed shape corresponding to the shape of the tooth portion 32 of the worm gear 14. With this configuration of the post-processing device 1, the contact area between the worm wheel 15 and the worm gear 14 is increased. Therefore, deformation of the worm gear 14 and the worm wheel 15 during driving is less likely to occur, and noise is less likely to generate. In the post-processing device 1, the reduction ratio of the first power transmission part 10 is greater than the reduction ratio from the second power transmission part 20 to the sheet discharge tray 4. Therefore, the rotation speed of the worm gear 14 can be reduced, thereby further suppressing noise generation.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sheet stacking device comprising:
a drive motor;
a power transmission mechanism configured to transmit power from the drive motor; and
a tray capable of stacking of sheets thereon, the tray configured to move up and down by the power transmitted through the power transmission mechanism, wherein
the power transmission mechanism includes:
a first power transmission part configured to reduce and transmit the power from the drive motor; and
a second power transmission part configured to reduce and transmit the power from the first power transmission part,
the second power transmission part includes:
a worm gear having a gear shaft portion and a tooth portion, the gear shaft portion being rotationally driven by the power from the first power transmission part, the gear shaft portion having an outer circumferential surface, the tooth portion having a helical shape, the tooth portion being on the outer circumferential surface of the gear shaft portion; and
a worm wheel engaged with the worm gear, and wherein
the worm wheel has an engagement recessed portion,
the engagement recessed portion is engaged with the tooth portion,
the engagement recessed portion has a curved recessed shape corresponding to a shape of the tooth portion when viewed from a direction parallel to a worm-gear axis of the worm gear, and
a reduction ratio of the first power transmission part is greater than a reduction ratio from the second power transmission part to the tray.

2. The sheet stacking device according to claim 1, wherein
in a cross-section orthogonal to the worm-gear axis, a distance between an inner circumferential edge of the engagement recessed portion and an outer circumferential edge of the tooth portion is constant on a circumference of the tooth portion.

3. The sheet stacking device according to claim 1, further comprising
support portions configured to rotatably support the worm gear, wherein
at least one of the support portions faces at least one end portion of the gear shaft portion, and
the worm gear includes a resin.

4. The sheet stacking device according to claim 1, wherein
the first power transmission part includes:
a first pulley attached to a rotating shaft of the drive motor;
a belt wound around the first pulley to transmit the power from the first pulley; and
a second pulley configured to rotate due to driving of the belt and thereby rotationally drive the gear shaft portion.

5. The sheet stacking device according to claim 4, wherein
the first power transmission part includes a first shaft,
the second pulley is attached to the first shaft,
the belt is stretched between the first pulley and the second pulley,
the belt transmits the power from the first pulley to the second pulley, and
the second pulley rotates due to driving of the belt and thereby rotationally drive the worm gear.

6. The sheet stacking device according to claim 1, wherein
the power transmission mechanism further includes a third power transmission part configured to reduce and transmit the power from the second power transmission part; and
at least one of gears constituting the third power transmission part includes a resin.

7. The sheet stacking device according to claim 6, wherein
the third power transmission part includes a first gear, a second gear, a third gear, a fourth gear, a second shaft, and a third shaft.

8. The sheet stacking device according to claim 7, wherein
the second power transmission part includes a worm wheel shaft,
the first gear is attached to the worm wheel shaft,
the first gear is disposed coaxially with the worm wheel, and
the first gear and the worm wheel are integrally rotatable.

9. The sheet stacking device according to claim 8, wherein
the second gear and the third gear are attached to the second shaft,
the second gear is engaged with the first gear,
the third gear is disposed coaxially with the second gear,
the second gear and the third gear are integrally rotatable,
the second shaft is parallel to the worm wheel shaft,
the fourth gear is attached to the third shaft,
the fourth gear is engaged with the third gear, and
the third shaft is parallel to the second shaft.

10. The sheet stacking device according to claim 7, wherein
the power transmission mechanism further includes a fourth power transmission part,
the fourth power transmission part includes a fifth gear, a fourth shaft, a timing pulley, and the timing belt, and
the third power transmission part is configured to transmit the power from the second power transmission part to the fourth power transmission part.

11. The sheet stacking device according to claim 10, wherein
the fifth gear is attached to the fourth shaft,
the fifth gear is engaged with the fourth gear,
the fourth shaft is parallel to the third shaft,
the timing pulley is attached to the fourth shaft,
the timing pulley is disposed coaxially with the fifth gear,
the fifth gear and the timing pulley are integrally rotatable,
the timing belt is wound around the timing pulley, and
the timing pulley is configured to rotate in accordance with rotation of the timing pulley.

12. The sheet stacking device according to claim 10, wherein
the fourth power transmission part is configured to transmit power from the third power transmission part to the tray.

13. The sheet stacking device according to claim 10, wherein
a reduction ratio from the second power transmission part to the tray is a reduction ratio from the second power transmission part to the fourth power transmission part via the third power transmission part.

14. The sheet stacking device according to claim 3, comprising
two support portions, wherein
one of the two support portions faces a first end portion of the gear shaft portion,
the other of the two support portions faces a second end portion of the gear shaft portion, and
the second end portion is opposite to the first end portion.

15. The sheet stacking device according to claim 1, wherein
the worm wheel has a plurality of engagement recessed portions and a plurality of engagement protruding portions,
the plurality of engagement recessed portions and the plurality of engagement protruding portions are alternately formed,
each of the plurality of engagement protruding portions has a first end and a second end when viewed from a direction parallel to the worm-gear axis,
the first end has a first notch,
the second end has a second notch,
the first notch has a shape in which a portion including the first notch is cut away, and
the second notch has a shape in which a portion including the second notch is cut away.

16. The sheet stacking device according to claim 15, wherein
the worm wheel has a worm-wheel axis,
the worm-wheel axis is orthogonal to the worm-gear axis,
the worm wheel has a main surface perpendicular to the worm-wheel axis, and
a degree of inclination of an inner circumferential edge of the engagement protruding portion with respect to the worm-wheel axis increases in a direction approaching the main surface and decreases at each of the first notch and the second notch.

17. The sheet stacking device according to claim 15, wherein
an end surface of each of the first notch and the second notch is a surface perpendicular to a radial direction of the worm wheel.

18. The sheet stacking device according to claim 15, wherein
the worm wheel has a worm-wheel axis,
the worm-wheel axis is orthogonal to the worm-gear axis,
an end surface of each of the first notch and the second notch is a surface parallel to the worm-wheel axis.

19. The sheet stacking device according to claim 8, wherein
the power transmission mechanism includes a support structure, and
the support structure includes a first main plate, a second main plate, a first side plate, a second side plate, a top plate, and a connection portion.

20. The sheet stacking device according to claim 19, wherein
the first main plate and the second main plate rotatably support the worm wheel shaft, the second shaft, and the third shaft.
